(19) United States
(12) Patent Application Publication
(10) Pub. No.: US 2009/0015616 A1
(43) Pub. Date: Jan. 15, 2009

(54) Liquid ejection control apparatus, liquid ejection control method and liquid ejection apparatus

(75) Inventor: Toru Miyamoto, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/218,270

(22) Filed: Jul. 14, 2008

(30) Foreign Application Priority Data
Jul. 13, 2007 (JP) 2007-184649

(51) Int. Cl. B41J 29/38

(52) U.S. Cl. 347/14

(57) ABSTRACT

A liquid ejection control apparatus which controls a liquid ejection mechanism having a plurality of nozzle groups made up of a plurality of nozzles for ejecting liquid, comprising: a usage ratio determination unit which determines a usage ratio between the plurality of nozzle groups when performing liquid ejection; a correction data generation unit which generates correction data corresponding to the determined usage ratio, by using respective correction data for correcting density of liquid ejection results corresponding respectively to a plurality of usage ratios between the nozzle groups; an image data correction unit which corrects prescribed image data on the basis of the generated correction data; and an ejection execution control unit which executes liquid ejection by driving the respective nozzle groups on the basis of the corrected image data and the determined usage ratio.

The entire disclosure of Japanese Patent Application No. 2007-184649, filed Jul. 13, 2007, is expressly incorporated by reference herein.

### BACKGROUND OF THE INVENTION

1. Technical field

The present invention relates to a liquid ejection control apparatus, a liquid ejection control method and a liquid ejection apparatus.

2. Related Art

There are printers which carry out printing by forming a plurality of nozzles for ejecting ink, in which nozzle rows for ejecting inks of respective colors are arranged respectively in multiple layers (in a plurality of rows). In a printer of this kind, it is possible to use selectively, for each color, nozzles of one nozzle row (called “main nozzle row” where appropriate), and nozzles of another nozzle row (called “back-up nozzle row” where appropriate). More specifically, when printing one image, either only the main (or back-up) nozzle rows are used, or the nozzles of the main nozzle rows and the nozzles of the back-up nozzle rows are used selectively for printing, at a prescribed usage rate.

In the respective nozzles, there may be fluctuation in the ink ejection volume and/or fluctuation in the ink ejection direction (these fluctuations are referred to jointly as fluctuation in the ink ejection characteristics). Fluctuation in the ink ejection characteristics is a cause of density non-uniformities in the lines corresponding to the respective nozzles, in the print result. In order to suppress the occurrence of density non-uniformities of this kind, in International Patent No. WO2005/042255, for each nozzle, a correction value for each line caused by the fluctuation in the ink ejection characteristics of the nozzle is acquired in advance on the basis of the print results of a prescribed test pattern, and during print processing, the respective pixels of the image data representing the image to be printed are corrected by means of the correction values.

As described above, in a printer having multiplexed nozzle rows, main nozzle rows and back-up nozzle rows may be used in combination when printing one image. Here, there are various modes for selectively using the two nozzle rows, from the viewpoint of dealing with heat in the nozzles, and avoiding the use of defective nozzles, and the like. Furthermore, in order to obtain good print results, it is necessary to subject the image data to correction for suppressing the density non-uniformities described above. However, the degree of correction applied to the respective pixels of the image data varies depending on the mode of selective use of the nozzle rows. Therefore, in order to obtain good print results at all times, using a printer having nozzle rows arranged in multiple layers, the volume of data required for correction becomes very large, and there is a problem in that the system for performing correction becomes highly complicated.

### SUMMARY

An advantage of some aspects of the present invention is to provide a liquid ejection control apparatus, a liquid ejection control method and a liquid ejection apparatus, whereby good liquid ejection results can be obtained at all times, by executing correction suited to the mode of selective use of a plurality of groups of nozzles, by means of simple processing involving a small data volume.

The liquid ejection control apparatus according to the invention controls a liquid ejection mechanism having a plurality of nozzle groups made up of a plurality of nozzles for ejecting liquid. A usage ratio determination unit determines a usage ratio between the plurality of nozzle groups when performing liquid ejection. For example, if there are two nozzle groups, then the usage ratio determination unit decides the usage ratios between one nozzle group and the other nozzle group. A correction data generation unit generates correction data corresponding to the determined usage ratio, by using respective correction data for correcting density of liquid ejection results corresponding respectively to a plurality of usage ratios between the nozzle groups. An image data correction unit corrects prescribed image data on the basis of the generated correction data. An ejection execution control unit executes liquid ejection by driving the respective nozzle groups on the basis of the corrected image data and the determined usage ratio.

In this way, according to the invention, it is possible to generate correction data corresponding to any usage ratio, by using respective correction data for correcting the densities of the liquid ejection results which correspond respectively to the plurality of usage ratios between the nozzle groups. Therefore, the volume of data required for correcting the image data in order to eject liquid by selective use of a plurality of nozzle groups, according to various different usage ratios, is extremely small. Moreover, the liquid ejection results obtained will have been compensated for deviation in the liquid ejection characteristics of the respective nozzle groups, in accordance with the usage ratio between the respective nozzle groups used for liquid ejection. Therefore, good output results with suitable restriction of density non-uniformities are obtained in the overall image.

The correction data generation unit may also generate correction data corresponding to the determined usage ratio, by acquiring the respective correction data corresponding to the plurality of usage ratios (correction data for correcting the densities of the liquid ejection results corresponding respectively to a plurality of usage ratios between the nozzle groups), and carrying out interpolation in accordance with the determined usage ratio by referring to the respective correction data thus acquired. Here, the acquisition of correction data includes: a process of inputting correction data from an external apparatus, a process of reading out correction data previously stored on a storage medium provided in the liquid ejection control apparatus, or processing for generating correction data, and the like. According to this composition, it is possible to obtain correction data corresponding to the determined usage ratio, by means of the simple method of interpolation.

In a further compositional example, the correction data generation unit acquires coefficients of an approximation formula obtained by interpolation on the basis of the respective correction data corresponding to the plurality of usage ratios, and generates correction data corresponding to the determined usage ratio on the basis of the coefficients and the determined usage ratio. In other words, instead of interpolation with reference to the actual correction data relating to the plurality of usage ratios, the coefficients of the approximation formula for the interpolation which is obtained on the basis of the respective correction data relating to the plurality of usage ratios is acquired as an information element, and the correction data required for the current liquid ejection control processing is generated on the basis of this coefficient. According to this composition, it is possible to reduce yet further the volume of data required for correction of the image data when liquid is ejected by making selective use of a plurality of nozzle groups, according to a prescribed ratio.

Here, the usage ratio determination unit may determine the usage ratio on the basis of the state of the liquid ejection mechanism or an instruction from an external source. According to this composition, it is possible to determine the usage ratio between the respective nozzle groups used for liquid ejection, in accordance with the state of the liquid ejection mechanism, or the wishes of the user, or the like.

In one example, the usage ratio determination unit acquires temperature of the nozzle group and determines the usage ratio in accordance with this temperature. Increase in the nozzle temperature is a case of problems in liquid ejection. Therefore, for example, if the temperature in one nozzle group is high, then the usage ratio between the nozzle groups is determined in such a manner that the usage rate of that one nozzle group is lowered and the usage rate of the other nozzle group is raised.

In another example, the usage ratio determination unit acquires ejection defect information for the nozzle group, and determines the usage ratio on the basis of this ejection defect information. In this case, for example, if information indicating an ejection defect is acquired in relation to one nozzle group, then the usage ratio is determined in such a manner that the usage rate of the other nozzle group is raised above the rate used hitherto, or the usage rate of the other nozzle group is raised to 100%.

In a further compositional example of the invention, the correction data generation unit acquires correction values relating to each line for correcting deviation in densities of the each line, from respective liquid ejection results corresponding to respective usage ratios, which form the respective correction data corresponding to the plurality of usage ratios. And, by interpolation, or the like, the correction data generation unit generates correction values for each line corresponding to the determined usage ratio. The image data correction unit corrects graduated tone values of respective pixels in the image data, by using the correction values generated in relation to the lines corresponding to the respective pixels. According to this composition, when liquid is ejected by using respective nozzle groups at a determined usage ratio, it is possible to obtain good output results in which the density non-uniformities of each line are respectively suppressed.

There are also cases where, rather than the respective nozzles in a nozzle group each having different liquid ejection characteristics, a unit of a certain number of numbers may all tend to have distinctive liquid ejection characteristics. In other words, within a region corresponding to a group of a certain number of nozzles (group of lines) in the liquid ejection results for a particular nozzle group, there is the same tendency in terms of density deviation. The same roughly applies to a case where the plurality of nozzle groups are used at a prescribed ratio. Therefore, in a further compositional example of the invention, the correction data generation unit acquires correction values in relation to each line group in units of the prescribed number of lines for correcting deviation in the density of each line group, from respective liquid ejection results corresponding to respective usage ratios, which form the respective correction data corresponding to the plurality of usage ratios. And, the correction data generation unit generates a correction value for each line group corresponding to the determined usage ratio, by interpolation, or the like. And the image data correction unit corrects graduated tone values of respective pixels in the image data on the basis of the correction values generated in relation to the line group to which each pixel corresponds. According to this composition, compared to a case where correction is made by using correction values for each line, only a small volume of correction data has to be acquired and generated, and a good output result can be obtained in which density non-uniformities caused by fluctuations in the liquid ejection characteristics of the nozzles in a group in units of the prescribed number of nozzles are suppressed.

Thus far, the technical concepts of the invention have been described in relation to a liquid ejection control apparatus, but these technical concepts may also be conceived as inventions relating to a method or a program product. In other words, it is also possible to conceive a liquid ejection control method comprising respective processes which correspond to the respective units provided in the liquid ejection control apparatus described above, or a program product which causes a computer to execute functions corresponding to these respective units.

Moreover, as an invention of product which displays similar actions and effects to the liquid ejection control apparatus described above, it is possible to conceive a liquid ejection apparatus having a plurality of nozzle groups made up of a plurality of nozzles for ejecting liquid; comprising: a usage ratio determination unit which determines a usage ratio between the plurality of nozzle groups when performing liquid ejection; a correction data generation unit which generates correction data corresponding to the determined usage ratio, by using respective correction data for correcting density of liquid ejection results corresponding respectively to a plurality of usage ratios between the nozzle groups; an image data correction unit which corrects prescribed image data on the basis of the generated correction data; and an ejection execution unit which executes liquid ejection by controlling driving of the respective nozzle groups on the basis of the corrected image data and the determined usage ratio.

### BRIEF DESCRIPTION OF THE DRAWINGS

FIG. 1 shows one example of a diagram showing the general composition of an apparatus relating to an embodiment of the invention;

FIG. 2 is a diagram showing one example of a print head unit;

FIG. 3 is a diagram showing one example of a print head unit;

FIG. 4 is one example of a flowchart showing the contents of a correction data generation process;

FIG. 5 is a diagram showing one example of a test pattern;

FIG. 6 is a diagram showing one example of the measurement results of a test pattern;

FIG. 7 is a diagram showing one example of correction data;

FIG. 8 is a diagram showing one example of the relationship between pixels and nozzle groups in a test pattern;

FIG. 9 is a diagram showing one example of the relationship between pixels and nozzle groups in a test pattern;

FIG. 10 is one example of a flowchart showing the contents of a print control process;

FIG. 11 is one example of a flowchart showing a process for generating correction data corresponding to a determined usage ratio;

FIG. 12 is one example of an illustrative diagram showing a mode of interpolating a correction value;

FIG. 13 is one example of an illustrative diagram showing a process for generating correction data corresponding to a determined usage ratio;

FIG. 14 is one example of a flowchart showing the details of an image data correction process;

FIG. 15 is a diagram showing one example of corrective function;

FIG. 16 is a diagram showing one example of usage ratio determination table;

FIG. 17 is a diagram showing one example of the aspect of temperature change in respective multiplexed nozzle rows;

FIG. 18 is one example of a diagram showing a mode of determining coefficients relating to correction coefficient data;

FIG. 19 is a diagram showing one example of correction coefficient data; and

FIG. 20 is a diagram showing one example of a print head unit.

### DESCRIPTION OF EXEMPLARY EMBODIMENTS

Embodiments of the invention are described below according to the following sequence.

1. General composition of apparatus

2. Acquisition of correction data

3. Liquid ejection control processing

4. Determination of usage rate

5. Modification examples

6. Summary

1. General Composition of Apparatus

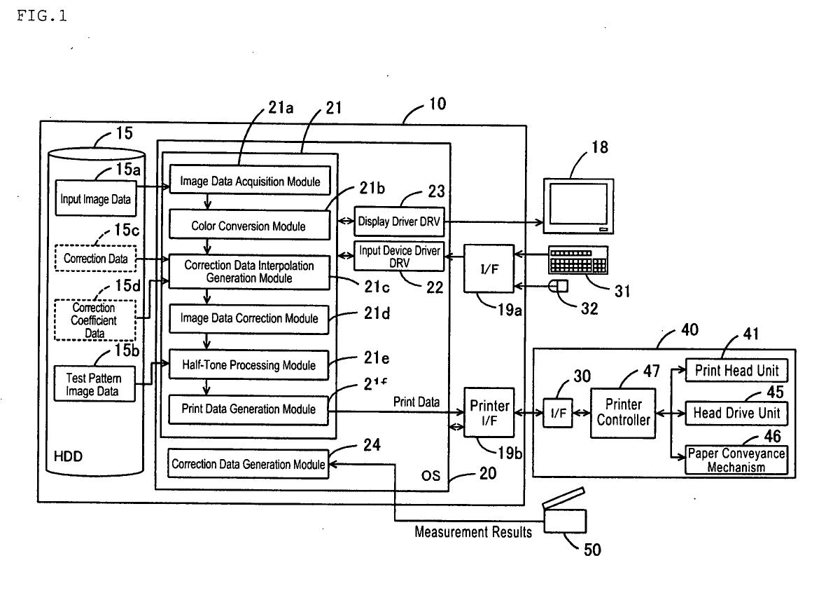

FIG. 1 shows the general composition of a computer, and the like, which relates to the present embodiment. The computer 10 comprises a CPU (not shown) which forms a kernel for calculation processing, a ROM forming a storage medium, a RAM, and the like, and it executes a prescribed program while using peripheral devices, such as the HDD 15. A printer 40 which forms a printing apparatus is connected to the computer 10 via a printer interface 19b (for example, a serial interface). Apart from this, the computer 10 is also connected via an interface 19a to operating input devices, such as a keyboard 31, a mouse 32, or the like, and furthermore, it is also connected to a display monitor 18 via a video board, which is not shown. The computer 10 is the main control apparatus for the printer 40, and it forms a liquid ejection control apparatus. Furthermore, the computer 10, the printer 40, and other apparatuses may be referred to jointly as a single liquid ejection control apparatus.

In the computer 10, a printer driver 21, an input apparatus driver 22 and a display driver 23 are incorporated into the OS 20. The display driver 23 is a driver which controls the display of the image to be printed, and the prescribed user interface (UI) screen, and the like, on the display monitor 18. The input apparatus driver 22 is a driver which accepts prescribed input operations by receiving code signals from a keyboard 31 or mouse 32, via the interface 19a.

The printer driver 21 can execute the printing of the printer 40 (printing being one type of liquid ejection) by carrying out prescribed image processing in respect of the image which has been instructed for printing by the application program (not shown). In order to implement print control, the printer driver 21 comprises: an image data acquisition module 21a, a color conversion module 21b, a correction data interpolation module 21c, an image data correction module 21d, a half-tone processing module 21e, and a print data generation module 21f. Furthermore, the OS 20 also incorporates a correction data generation module 24 for previously generating correction data, which is described hereinafter.

The printer driver 21 is driven when a print instruction as described above is issued, and the printer driver 21 sends data to the display driver 23, where the aforementioned User Interface (UI) screen is displayed. When the user has input the required print conditions, as appropriate, via the UI screen, by operating the keyboard 31, mouse 32, or the like, the respective modules of the printer driver 21 are started up, and the respective modules carry out processing for each pixel of the input image data (image data which represents the image to be printed) 15a, thereby creating print data (raster data). The raster data thus created is output to the printer 40 via the printer interface 19b, and the printer 40 executes printing on the basis of this raster data. The functions of the respective modules are described hereinafter.

The printer 40 comprises a print head unit 41 which ejects inks (one type of liquid) of a plurality of colors onto printing paper. In one example of the present embodiment, the printer 40 ejects inks of the respective colors of cyan (C), magenta (M), yellow (Y) and black (K). The printer 40 can also create a plurality of colors by combining the inks of the respective colors, and thereby forms a color image on the printing paper. The number of inks and type of ink used in the printer 40 are not limited to those described above, and it is possible to use inks of various types, such as Lc (light cyan), Lm (light magenta), Lk (gray), light gray (LLk), and so on.

The printer 40 comprises a communications interface 30 which connects with the printer interface 19b, and two-way communications between the computer 10 and the printer 40 are conducted via the printer interface 19b and the communications interface 30. The communications interface 30 can receive separate raster data for each ink type which has been sent by the computer 10. Furthermore, the printer 40 comprises a CPU (not shown), and storage media including a ROM, RAM, and the like, and it executes a prescribed program (printer controller 47). The printer controller 47 is a program which executes various controls for print processing, and it controls various mechanisms inside the printer 40, such as the print head unit (one type of liquid ejection mechanism) 41, the head drive unit 45, the paper supply mechanism 46, and the like.

The print head unit 41 comprises a plurality of nozzles for ejecting inks of respective colors, and is mounted with ink cartridges for supplying inks of the respective colors to the nozzles corresponding to those colors. In the present embodiment, the printer 40 is taken to be a so-called line head printer. Therefore, a plurality of nozzles are arranged densely in a direction perpendicular to the paper feed direction of the print paper in the print head unit 41. The printer 40 may also use a serial type of print head. The printer controller 47 outputs application voltage data corresponding to the raster data described above, to the head drive unit 45. From the application voltage data, the head drive unit 45 generates an application voltage pattern (drive signals) for the piezoelectric elements which are disposed so as to correspond respectively to the nozzles of the print head unit 41, and it ejects ink droplets (dots) of the inks of respective colors, from the print head unit 41. However, for the method of ejecting dots, apart from a method which uses the deformation of piezoelectric elements by means of a drive signal as described above, it is also possible to use various other methods, such as a thermal ejection method. The paper feed mechanism 46 is controlled by the printer controller 47 so as to convey printing paper in a prescribed paper conveyance direction, by means of paper conveyance rollers, which are not illustrated.

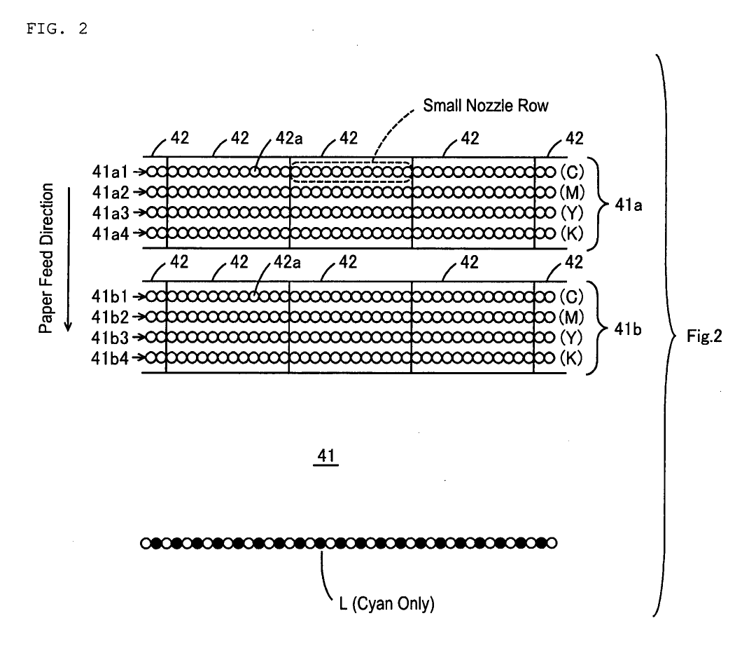

FIG. 2 shows an example of one portion of a surface in which nozzles are arranged in the print head unit 41. As shown in FIG. 2, the print head unit 41 is constituted by the first head unit 41a and the second head unit 41b. The first head unit 41a is formed by aligning a plurality of print heads 42 through a length corresponding substantially to the width of the printing paper, following the direction perpendicular to the paper feed direction, and in a similar fashion, the second head unit 41b is also formed by aligning a plurality of print heads 42 through a length corresponding substantially to the width of the printing paper, following the aforementioned perpendicular direction. Each of the print heads 42 is formed with rows of nozzles 42a of a number corresponding to the number of colors of ink used by the printer 40 (in the case of the present embodiment, four colors: C, M, Y, K). Therefore, in the first head unit 41a, nozzle rows 41a1, 41a2, 41a3, 41a4 of a length corresponding substantially to the width of the printing paper are formed, corresponding respectively to the different colors of ink, and similarly, in the second head unit 41b, nozzle rows 41b1, 41b2, 41b3, 41b4 of a length corresponding substantially to the width of the printing paper are formed, corresponding respectively to the different colors of ink. The number of nozzles 42a in each of the nozzle rows (nozzle row 41a1, 41a2, 41a3, 41a4, 41b1, 41b2, 41b3, 41b4) is N.

In this way, in the print head unit 41, the first head unit 41a and the second head unit 41b each comprise one row of nozzles for ejecting each color of ink, C, M, Y and K. In this sense, the print head unit 41 can be regarded as having multiplexed nozzle rows for ejecting each of the respective ink colors. Furthermore, the print head unit 41 also has a plurality of nozzle groups, in the sense that for each of the ink colors, a plurality of nozzle rows (which are one type of nozzle group) for ejecting that color are provided (for example, nozzle row 41a1 and nozzle row 41b1 corresponding to ink C are provided).

In the print head unit 41, the plurality of nozzle rows corresponding to the same ink color can be used selectively, in units of one dot. Here, a hypothetical case is described, in which, as shown in the lower part of FIG. 2, a raster line L is printed by a certain ink color (for example, C) only, following a direction which is perpendicular to the paper feed direction. In this case, in the print head unit 41, all of the N dots which constitute the raster line L could be printed by the nozzles 42a of nozzle row 41a1, and all of the dots could also be printed by the nozzles 42a of the nozzle row 41b1. Furthermore, it is also possible to switch the nozzle 42a used between the nozzle row 41a1 and the nozzle row 41b1, for each dot. For example, as shown in FIG. 2, the dots indicated by the white circles in raster line L can be printed by the nozzles 42a of the nozzle row 41a1, and the dots indicated by the black circles in raster line L can be printed by the nozzles 42a of the nozzle row 41b1. The switching of nozzles 42a between the nozzle rows in this way is carried out by means of the printer controller 47 selecting the output destination of the drive signal from the head drive unit 45 (namely, by selecting the piezoelectric element of the nozzle 42a that is to receive the signal).

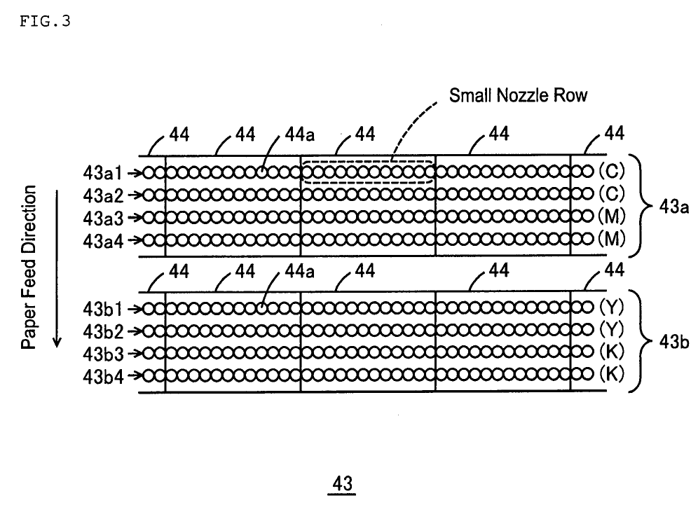

FIG. 3 shows a further example of the structure of a print head unit. The print head unit 43 shown in FIG. 3 comprises a first head unit 43a and a second head unit 43b, and both of the head units 43a and 43b are respectively formed by aligning a plurality of print heads 44 through a length corresponding substantially to the width of the printing paper, in the direction perpendicular to the paper feed direction. Furthermore, each of the print heads 44 is formed with a number of rows of nozzles 44a corresponding to the number of colors of ink used by the printer 40. However, in the print head unit 43, the nozzle rows 43a1, 43a2, 43a3, 43a4 of the first head unit 43a do not each correspond respectively to different ink colors, but rather, a composition is adopted in which two adjacent rows correspond to the same ink color. For example, the nozzle rows 43a1 and 43a2 are used for ejecting C ink, and the nozzle rows 43a3, 43a4 are used for ejecting M ink. Similarly, the nozzle rows 43b1, 43b2, 43b3, 43b4 of the second head unit 43b do not each correspond respectively to different ink colors, but rather, a composition is adopted in which two adjacent rows correspond to the same ink color. For example, the nozzle rows 43b1 and 43b2 are used for ejecting Y ink and the nozzle rows 43b3 and 43b4 are used for ejecting K ink.

Naturally, the structure of the print head unit used in the printer 40 is not limited to the modes shown in FIG. 2 or FIG. 3 described above, and it is possible to adopt any composition provided that a plurality of groups of nozzles for ejecting the respective ink colors are provided, for each color (in other words, provided that the nozzles are multiplexed).

The description give below relates to an example where the print head unit 41 is used as a print head unit.

2. Acquisition of Correction Data

In the present embodiment, in the process of converting the input image data 15a into print data, correctional processing is carried out in order to suppress density non-uniformities caused by the ink (liquid) ejection characteristics of the respective nozzles 42a of the print head unit 41. This correction processing is carried out using correction data which has been generated previously, or correction data which is generated newly, as and when necessary, by interpolating the previously generated correction data.

Below, firstly, the process of generating correction data which is carried out previously to the print processing on the basis of the input image data 15a will be described.

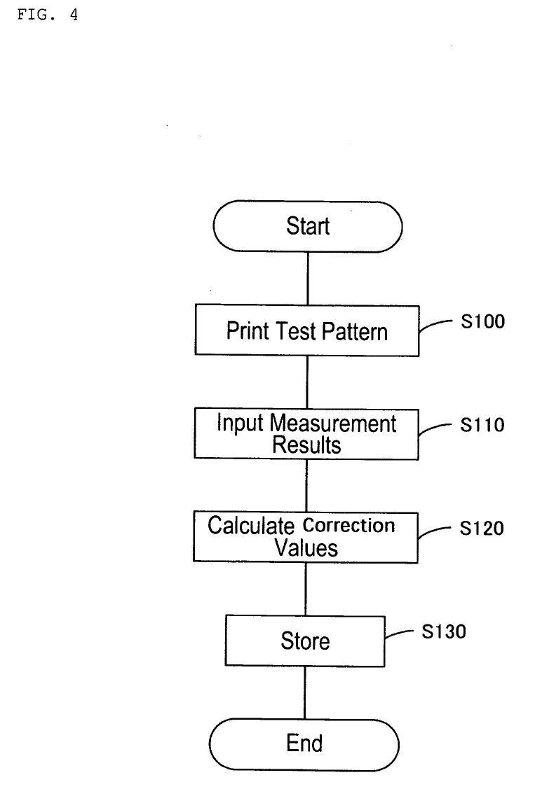

FIG. 4 shows the contents of the correction data generation processing which is executed by the computer 10. In the present embodiment, correction data which corresponds respectively to a plurality of usage ratios is generated, on the basis of the measurement results of respective test patterns printed at different usage ratios between the nozzle groups which are in a multiplexed relationship. In one example, correction data respectively corresponding to a first to a third usage ratio are generated on the basis of the measurement results for: a test pattern TP1 which is printed at a usage ratio of 100% to 0% (called a “first usage ratio” for convenience) between the first nozzle rows (the nozzle rows 41a1, 41a2, 41a3, 41a4 of the first head unit 41a) and the other nozzle rows (the nozzle rows 41b1, 41b2, 41b3, 41b4 of the second head unit 41b) which are related in the multiplex nozzle arrangement; a test pattern TP2 which is printed at a usage ratio between the one nozzle rows and the other nozzle rows of 50% to 50% (called a “second usage ratio” for convenience); and a test pattern TP3 which is printed at a usage ratio between the one nozzle rows and the other nozzle rows of 0% to 100% (called a “third usage ratio” for convenience).

Here, the description relates to an example where test patterns are printed using the nozzle rows 41a1 and 41b1 which correspond to C ink.

At step S (used below as an abbreviation for “step”) 100, the computer 10 controls the printer 40 so as to print test patterns TP1 to TP3 with C ink using the nozzle rows 41a1, 41b1, respectively at the first to third usage ratios, onto the printing paper. Firstly, the printer driver 21 acquires test pattern image data 15b which represents a test pattern, from the HDD 15, or the like. The test pattern image data 15b is prepared in advance for each color of ink used by the printer 40. The test pattern image data 15b is data which defines each image pixel as a tonal value (for example, 256 tones, from 0 to 255) of a particular color, and the whole image represents a prescribed density pattern based on using this one ink color.

More specifically, the test pattern image data 15b according to the present embodiment represents an image in which respective density regions (for example, regions having a dot coverage ratio per prescribed unit surface area of 10%, 30%, 50%, 70% and 90%, respectively), which correspond to a plurality of graduated tone values (for example, graduated tone values p1, p2, p3, p4, p5), are arranged in sequence in the feed direction of the printing paper. The printer driver 21 transfers the test pattern image data 15b relating to C ink, to the half-tone processing module 21e. The half-tone processing module 21e executes a so-called half-toning process (binarization process) on the test pattern image data 15b, thereby generating half-tone data which specifies dot ejection (on) or dot non-ejection (off) for each pixel. The half-tone processing module 21e is able to execute half-toning by means of various methods, such as error diffusion, dithering, or the like.

Thereupon, the print data generation module 21f receives the half-tone data and generates sequentially rearranged C raster data for use by the printer 40, which it outputs successively to the printer 40. Identification information for identifying the nozzle row used to eject ink for each pixel is appended to the raster data. For example, when the test pattern TP1 is printed, identification information specifying the nozzle row 41a1 is appended for all of the pixels. Furthermore, when printing the test pattern TP2, identification information which specifies the nozzle row 41a1 for half of the pixels and specifies the nozzle row 41b1 for the remaining half of the pixels, is added. When the test pattern TP3 is printed, identification information specifying the nozzle row 41b1 is appended for all of the pixels. By this means, the printer 40 (printer controller 47) carries out printing while selecting the nozzle to which the drive signal is to be supplied. Consequently, the test patterns TP1 to TP3 created by ejection of C ink from the nozzles 42a of the nozzle rows 41a1 and 41b1 on the basis of the test pattern image data 15b are printed respectively onto the printing paper.

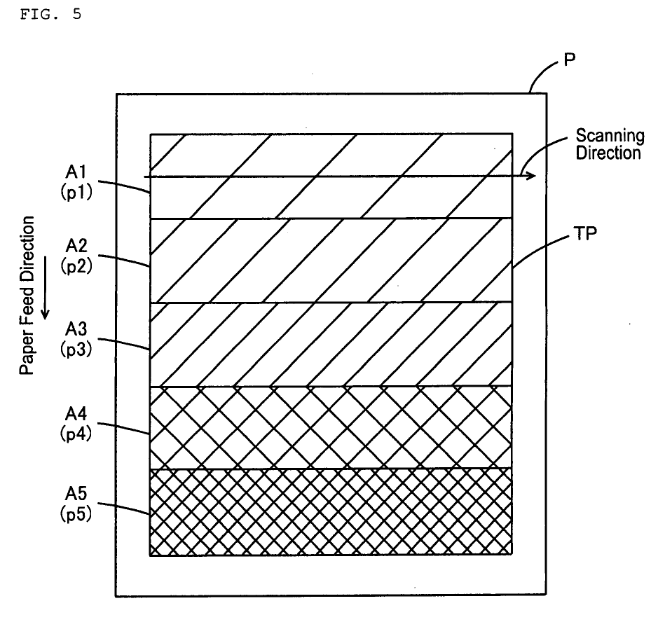

FIG. 5 shows one example of the test patterns described above, when printed. As shown in FIG. 5, a test pattern (here, the test pattern TP1) having a density which changes in step fashion in the paper feed direction is printed onto printing paper P. In FIG. 5, the respective regions of different density in the test pattern TP1 are indicated as density regions A1 to A5. Furthermore, there is also a correspondence between the density regions A1 to A5, and the graduated tone values p1 to p5 which are represented by the density regions A1 to A5 in the test pattern image data 15b. Of course, the test patterns T2 and T3 which are printed on separate sheets (not shown) are also formed with density regions A1 to A5 corresponding to the graduated tone values p1 to p5, similarly to FIG. 5.

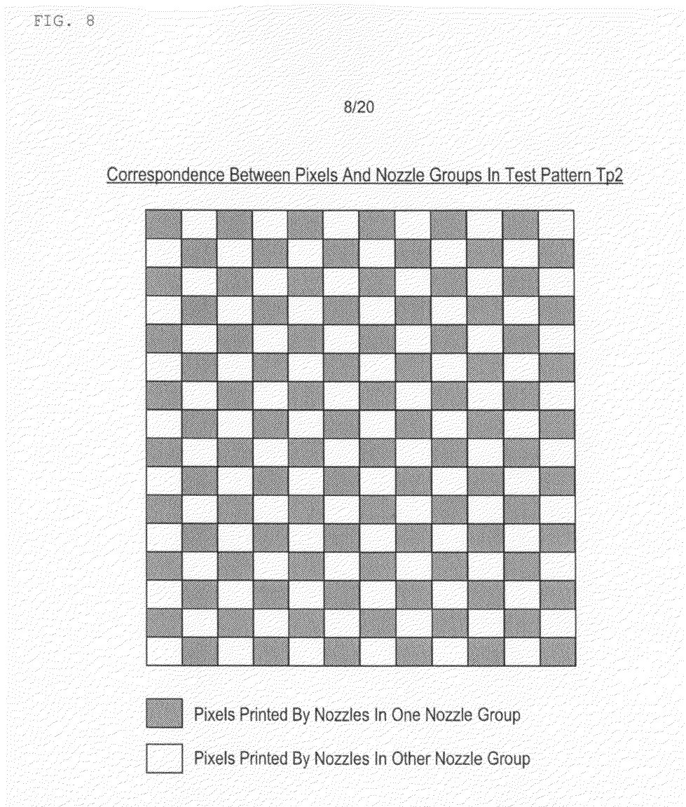

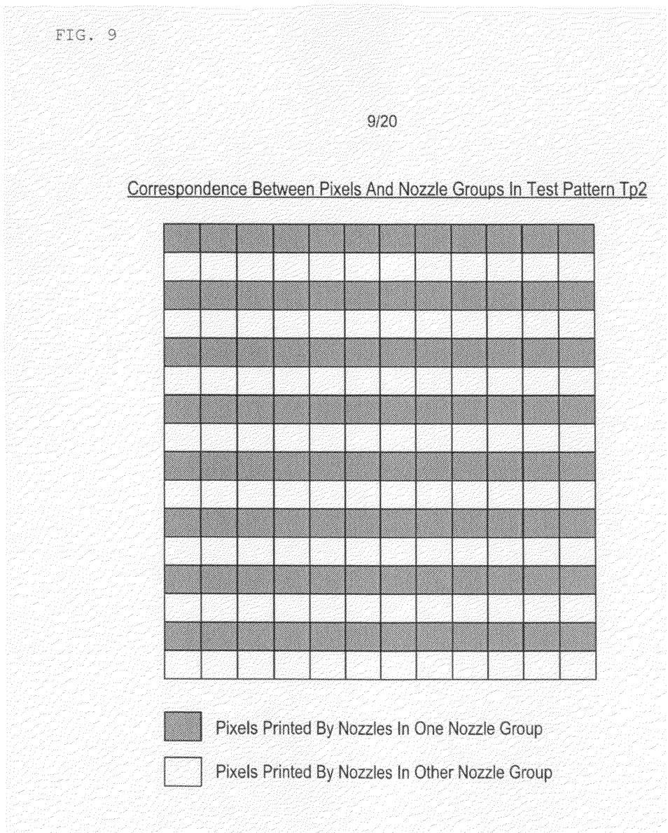

FIGS. 8 and 9 show examples of the correspondence between the pixels and the nozzle groups, when printing the test pattern TP2 which corresponds to the second usage ratio. In other words, if a test pattern is printed at a usage ratio of 50% to 50% between the one nozzle group (nozzle row 41a1) and the other nozzle group (nozzle row 41b1) which are in a multiplexed relationship, then as shown in FIG. 8, the pixels are divided up into two groups in a checkerboard pattern, and one of the pixel groups is set to be printed by the nozzles of one nozzle group, while the other pixel group is set to be printed by the nozzles of the other nozzle group. Alternatively, as shown in FIG. 9, the pixels are divided into two groups by taking every other line of pixels, and one pixel group is set to be printed by the nozzles of one nozzle group, while the other pixel group is set to be printed by the nozzles of the other nozzle group. In the present embodiment, if a test pattern is printed by using the one nozzle group and the other nozzle group which are in a multiplexed relationship, at a prescribed usage ratio, then desirably, the nozzles are used selectively in accordance with the prescribed usage ratio, for each respective pixel column of the image data (namely, vertical columns which following the paper feed direction).

Next, at S110, the computer 10 inputs measurement results for the test patterns TP1 to TP3 as obtained by a prescribed measurement device. As shown in FIG. 1, a density measurement device 50 (for example, a scanner) is connected to the computer 10. By scanning the density measurement device 50 over the test patterns TP1 to TP3, it is possible to measure optically the density of prescribed positions on the test patterns TP1 to TP3, and the corresponding measurement results are gathered in the form of luminosity information L having 256 tonal values, for example. In S110 described above, the computer 10 controls the density measurement device 50 so as to respectively measure the density of the density regions A1 to A5 in the test patterns TP1 to TP3. In this case, for each density region, as indicated by the arrow in FIG. 5, measurement is performed by scanning over a prescribed path following the breadthways direction of the test pattern (a direction perpendicular to the paper feed direction), at a pitch corresponding to the pitch of the nozzles 42a in the nozzle row, and hence measurement results for N measurement positions corresponding to the (N) nozzles are input. At each of these measurement positions, desirably, a range corresponding to a plurality of dots aligned in the paper feed direction is measured, and the average value of the luminosity within the measured range is taken as the measurement result.

At S120, the computer 10 calculates a correction value for each of the lines in the paper feed direction, which have been printed in accordance with the number of nozzles N in the print result, on the basis of the measurement results for the test patterns TP1 to TP3 input at S110. This calculation processing is carried out by the correction data generation module 24. In each of the test patterns TP1 to TP3, the number of lines is N.

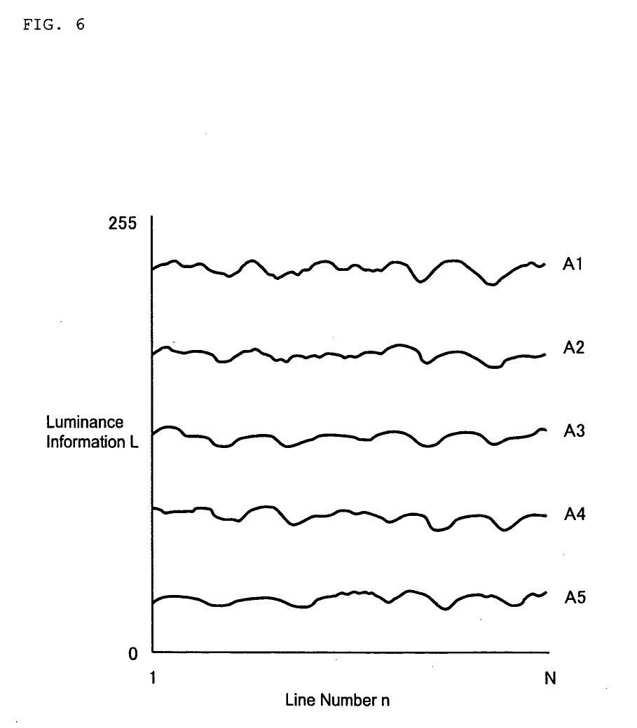

FIG. 6 shows one example of the measurement result of a certain test pattern (here, taken to be test pattern TP1) In FIG. 6, the vertical axis shows the measurement results (luminosity information L) of the respective density regions A1 to A5, and the horizontal axis shows the number n of the line in the test pattern (1≦n≦N). In other words, the measurement results for N positions in one density region of one test pattern indicate the densities of each of the N lines which constitute that one density region in that one test pattern. Ideally, the measurement results for the density regions A1 to A5 are as uniform as possible in the horizontal direction, but due to fluctuations in the ink ejection performance of the nozzles 42a used to print the test pattern, some variation occurs, as shown in FIG. 6.

For each density region A1 to A5 of the test patterns TP1 to TP3, the correction data generation module 24 calculates a corrective value Hn corresponding to each line number n, on the basis of the differential between a prescribed target density and the measurement result corresponding to each line number n.

For example, the correction data generation module 24 determines the average value Lav of the measurement results corresponding to the respective line numbers 1 to N, as obtained by the measurement of density region A11 of test pattern TP1 (called density region A11 for the sake of convenience), and this average value Lav is taken to be the target density for the density region A11. Thereupon, the correction data generation module 24 calculates the differential ΔL=|Lav−Ln| between this target density Lav and the measurement result Ln of one line number n obtained by the measurement of density region A11, and then sets a correction value h for this one line number n by dividing the differential ΔL by the average value Lav. In other words,

h=ΔL/Lav (1)

Here, if Ln>Lav, then the density of the print result at the aforementioned one line number n is brighter (less dense) than the target value, and therefore correction is applied in order to make the graduated tone values of the pixels corresponding to this one line number n greater than the original graduated tone value, by a factor of h. Thereby, the density printed by the nozzle 42a corresponding to the one line number n can be brought close to the target density. Therefore, in this case, the correction value Hn corresponding to the one line number n, which is derived from the measurement results for the density region A11 will be (100+h)/100.

On the other hand, if Ln<Lav, then the density of the print result at the aforementioned one line number n is darker (more dense) than the target value, and therefore correction is applied in order to make the graduated tone values of the pixels corresponding to this one line number n smaller than the original graduated tone value, by a factor of h. Thereby, the density printed by the nozzle 42a corresponding to the one line number n can be brought close to the target density. Therefore, in this case, the correction value Hn corresponding to the one line number n, which is derived from the measurement results for the density region A11 will be (100−h)/100. Here, the correction value Hn thus determined is valid only in respect of the usage ratio between the nozzle row 41a1 and the nozzle row 41b1 employed when printing the test pattern which is used as the source for calculating the correction value Hn.

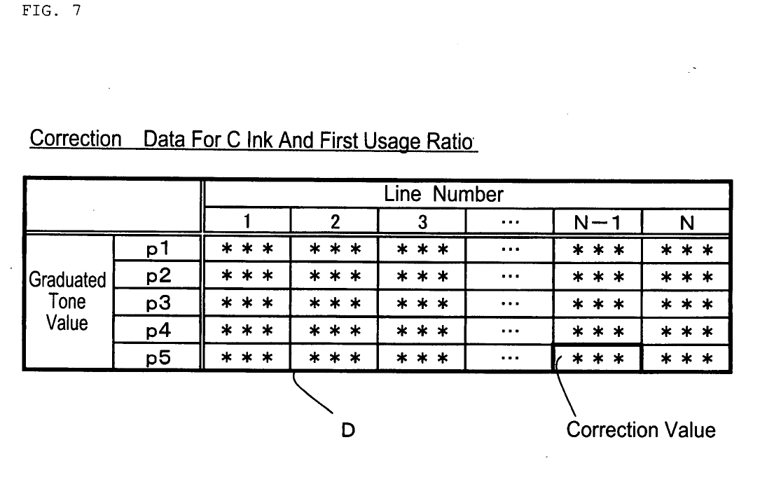

FIG. 7 shows one example correction data D obtained by the processing in S120. FIG. 7 shows correction data D consisting of correction values for each line number, and each graduated tone value (p1 to p5) of the respective density regions A1 to AS, as obtained from the measurement results of a test pattern TP1 printed using C ink. Naturally, correction data consisting of correction values for each graduated tone value p1 to p5 and each line number are also obtained respectively from the measurement results of the test patterns TP2 and TP3 which are printed with C ink. The number of graduated tone values (number of density regions) in the test patterns does not have to be five steps, as shown in FIG. 5, and this number may be varied as appropriate.

At S130, the computer 10 (correction data generation module 24) outputs the correction data generated as described above, to the printer 40, via the printer interface 19b, and the data is stored on a prescribed storage medium provided in the printer 40 (for example, a storage medium provided in the print head unit 41). The computer 10 also carries out the same processing as that shown in FIG. 4, successively, in respect of the groups of nozzle rows corresponding to the inks (MYK) other than C (namely, the group comprising nozzle row 41a2 and nozzle row 41b2, the group comprising nozzle row 41a3 and nozzle row 41b3, and the group comprising nozzle row 41a4 and nozzle row 41b4).

Consequently, correction data for each ink color CMYK and each of the first to third usage ratios is stored on the storage medium of the printer 40.

3. Liquid Ejection Control Processing

Next, the liquid ejection control process (print control process) which is associated with the correction processing using the correction data generated as described above will be explained.

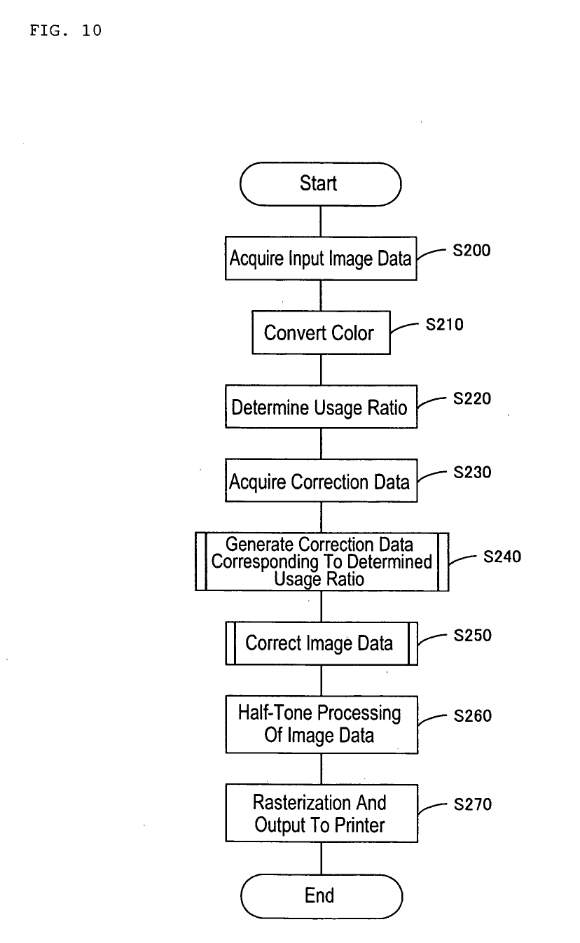

FIG. 10 is a flowchart showing the contents of print control processing which is executed by the computer 10. This processing is executed principally by the printer driver 21.

At S200, the image data acquisition module 21a acquires the input image data 15a from the HDD 15, or the like. The input image data 15a is dot matrix data which specifies the colors of the respective pixels, by representing tonal values of the respective color elements R (red), G (green), B (blue), and it uses a calorimetric system which complies with the sRGB standards. Naturally, it is also possible to use various other types of data, such as JPEG image data which uses a YCbCr calorimetric system, image data which uses a CMYK calorimetric system, or the like. Furthermore, the image data acquisition module 21a may also input image data from an image input apparatus, such as a digital still camera (not illustrated), or the like, which is connected to the computer 10, rather than the HDD 15.

In S200 described above, according to requirements, prescribed resolution conversion processing suited to the output resolution of the printer 40 is carried out on the input image data 15a.

At S210, the color conversion module 21b converts the calorimetric system of the input image data 15a to the calorimetric system of the ink colors used by the printer 40. More specifically, the color conversion module 21b refers to a color conversion look-up table (LUT) (not illustrated), which has been stored previously in the HDD 15, or the like, and converts the RGB data of the respective pixels of the input image data 15a into respective graduated tone values for C, M, Y and K (CMYK data). The color conversion LUT is a table which records universal associations between prescribed reference points (RGB data) in the sRGB color space and CMYK data. The color conversion module 21b is thereby able to convert any RGB data into CMYK data, by referring to the color conversion LUT and carrying out a suitable interpolation calculation, or the like. In the present embodiment, the respective values for CMYK before and after color conversion are represented in terms of 256 tonal values.

As stated previously, the print head unit 41 has multiplexed nozzle rows for ejecting each color of ink, respectively. Therefore, when carrying out printing on the basis of the input image data 15a, it is possible to combine the use of both of the related nozzle rows in the multiplexed arrangement.

Therefore, in S220, the correction data interpolation generating module 21c determines the usage ratio for the one nozzle row (nozzle row 41a1, 41a2, 41a3, 41a4) and the other nozzle row (41b, 41b2, 41b3, 41b4) of the nozzle rows which are in a multiplexed relationship, on the basis of prescribed standards. In executing the processing step S220 above, the correction data interpolation generation module 21c can be regarded as serving as a usage ratio determination unit.

The specific standards used for determining the usage ratio are described hereinafter.

At S230, the correction data interpolation generating module 21c acquires the correction data described above, from the printer 40, via the printer interface 19b. More specifically, the correction data interpolation module 21c outputs a correction data request signal to the printer 40, and upon receiving this request signal, the printer 40 reads out the correction data for each of the first to third usage ratios, and for each of the ink colors, CMYK, stored in the storage medium and outputs this data to the computer 10. Upon receiving the correction data, the correction data interpolation generating module 21c stores the correction data as correction data 15c in a prescribed storage region of the HDD 15, or the like.

At S240, the correction data interpolation generating module 21c uses the correction data 15c to generate new correction data corresponding to the usage ratio (determined usage ratio) determined in step S220. Here, an example is described in which the determined usage ratio (the usage ratio between the nozzle row 41a1 and the nozzle row 41b1, between the nozzle row 41a2 and the nozzle row 41b2, between the nozzle row 41a3 and the nozzle row 41b3, and between the nozzle row 41a4 and the nozzle row 41b4) is 75% to 25%.

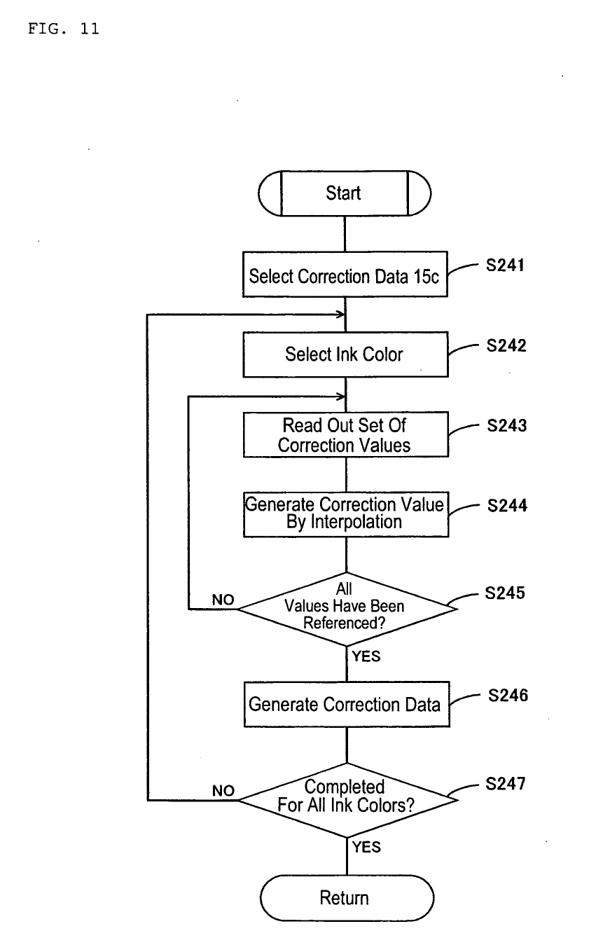

FIG. 11 is a flowchart showing details of the processing in step S240.

At S241, on the basis of the determined usage ratio, the correction data interpolation generating module 21c selects the correction data 15c relating to two usage ratios, as correction data to be used for subsequent interpolation processing, from among the respective correction data 15c relating to the first to third usage ratios. In other words, the correction data 15c relating to the two usage ratios closest to the determined usage ratio are selected, from the first to third usage ratios. Here, since the determined usage ratio is 75% to 25%, then the correction data 15c relating to the first usage ratio (100% to 0%) and the correction data 15c relating to the second usage ratio (50% to 50%) are selected, and the correction data 15c relating to the third usage ratio (0% to 100%) is not selected.

At S242, the correction data interpolation generating module 21c selects the correction data 15c corresponding to a common ink color (for example, cyan(C)), of the correction data 15c of the respective ink colors relating to the two usage ratios selected at S241 above.

At S243, one set of correction data having a matching graduated tone value and line number is read out, from either the one correction data 15c (the correction data relating to the C ink and the first usage ratio) or the other correction data 15c (the correction data relating to the C ink and the second usage ratio), which were selected in step S242 above.

At S244, a correctional value corresponding to the determined usage ratio is generated, through interpolation processing corresponding to the determined usage ratio, by referring to a set of correctional values which has been read out above.

For example, if the correctional value corresponding to the graduated tone value p1 and the line number 1 which was recorded in the correction data 15c relating to the C ink and the first usage ratio is “1.2”, and the correctional value corresponding to the graduated tone value p1 and the line number 1 which was recorded in the correction data 15c relating to the C ink and the second usage ratio is “1.1”, then by interpolation with reference to the correction value “1.2” and the correction value “1.1”, a new correction value corresponding to the graduated tone value p1 and the line number 1 is generated.

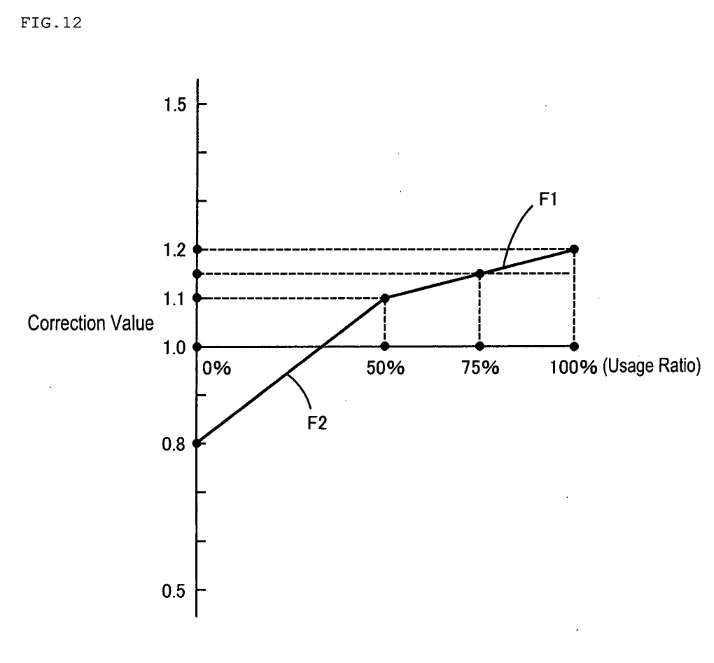

FIG. 12 shows one example of an aspect of generating a correction value by interpolation processing. FIG. 12 shows a two-dimensional plane in which the vertical axis represents the correction value, and the horizontal axis represents the usage ratio (0 to 100%) of one nozzle row which is in a multiplexed relationship. In FIG. 12, the correction value “1.1” is plotted at the position of the 50% usage ratio, the correction value “1.2” is plotted at the position of the 100% usage ratio, and a function F1 which links these two points by linear interpolation is shown. The correction value corresponding to the determined usage ratio (the usage ratio 75% of one nozzle row which is in a multiplexed relationship) is determined by means of this function F1. In FIG. 12, for the purposes of reference, the correction value corresponding to the graduated tone value p1 and the line number 1 (“0.8”) which was recorded in the correction data 15c relating to the C ink and a third usage ratio is plotted at the position of the 0% usage ratio, and a function F2 which links the point of this 0% usage ratio and the point of the 50% usage ratio is also shown. This function F2 is used if the usage ratio of the one nozzle row which is in a multiplexed relationship is 0 to 50%.

At S245, the correction data interpolation generating module 21c judges whether or not a new correction value has been generated, by referring to all of the sets of correctional values matching the graduated tone value and the line number, which have been recorded respectively in the correction data 15c relating to the two usage ratios for the ink color (C) which were selected as the nearest usage ratios in step S242. If there remain sets of correctional values which have not been referenced, then the procedure returns to S243, and the processing in S244 is implemented by reading out the set of correctional values which have not yet been referenced.

On the other hand, if there are no remaining sets of correctional values which have not been referenced, then the procedure advances to S246 and correction data corresponding to the determined usage ratio is generated on the basis of the respective correction values generated by the processing in step S244 above.

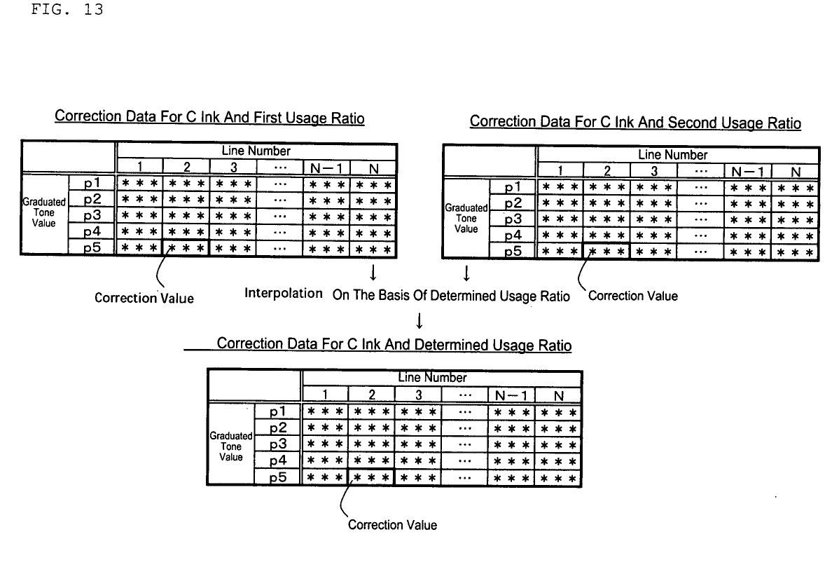

FIG. 13 shows a simplified view of a process of generating correction data corresponding to a determined usage ratio by interpolation processing with reference to the correction data 15c for two usage ratios relating to the ink color (C) which were selected at step S242 above, (this corresponds to steps S243 to S246).

At S247, the correction data interpolation generating module 21c judges whether or not correction data corresponding to the determined usage ratio has been generated in respect of all of the ink colors, and if there is an ink color which has not yet been selected, then the procedure returns to S242, the correction data 15c corresponding to the ink color that has not yet been selected is chosen from amongst the correction data 15c of the respective ink colors relating to the two usage ratios selected in step S241 above, and the processing from step S243 onwards is repeated. On the other hand, if generation of correction data corresponding to the determined usage ratios described above has been completed for all of the ink colors, then the processing in FIG. 11 is terminated.

By executing the processing in steps S230 and S240 in this way, the correction data interpolation generating module 21c can be considered to function as a correction data generation unit. Furthermore, considering the fact that the correction data generation module 24 previously generates correction data, then the correction data generation module 24 can also be regarded as constituting a portion of the correction data acquisition unit.

The description is now continued by returning to FIG. 10.

At step S250, the image data correction module 21d performs correction on the basis of the correction data corresponding to the determined usage ratio generated at step S240 above.

However, if the determined usage ratio matches either one of the first to third usage ratios, then the correction data 15c relating to the matching usage ratio is used directly as the correction data corresponding to the determined usage ratio. If the correction data 15c is used directly for correction of the image data in this way, then the processing in step S240 described above is not necessary.

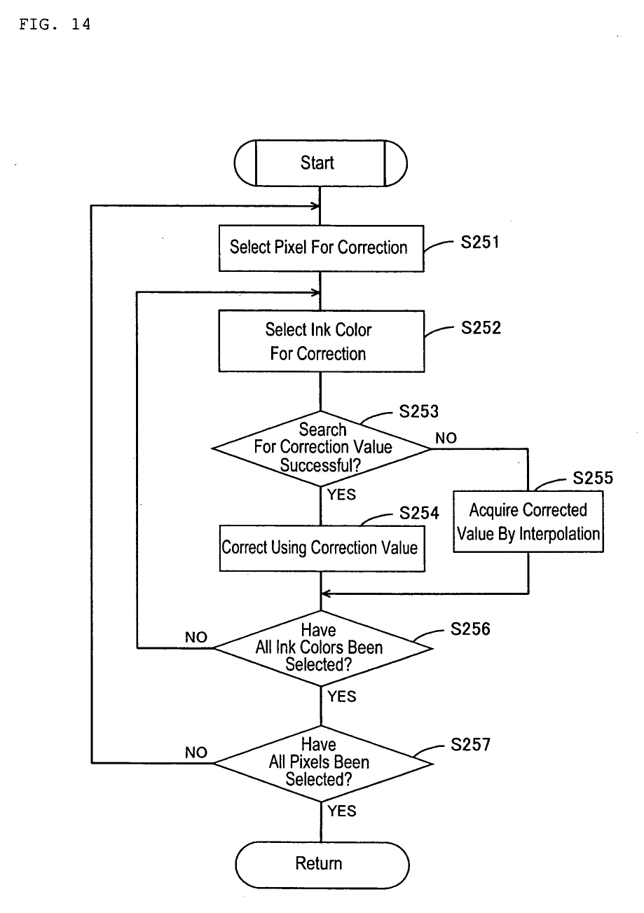

FIG. 14 is a flowchart showing details of the processing in step S250.

In S251, the image data correction module 21d selects one pixel for correction, according to a prescribed sequence, from the pixels which make up the image data. Basically, the pixels for correction are selected sequentially, starting from the left-most pixel of the uppermost pixel line.

At S252, the image data correction module 21d selects the graduated tone value relating to one ink color (for example, the graduated tone value of C) as the graduated tone value for correction, of the graduated tone values of the respective ink colors CMYK in the pixel which is currently under correction.

At S253, the image data correction module 21d searches the correction data corresponding to the determined usage ratio, to find a correction value corresponding to the graduated tone value of the ink color selected at S252. More specifically, the correction data corresponding to the ink color selected at step S252 above is read out from the correction data corresponding to the determined usage ratio. The image data correction module 21d then identifies whether or not there is a correction value corresponding to the graduated tone value selected for correction as described above, amongst the respective correction values relating to the line number which corresponds to the position of the pixel selected at S251 in the correction data which has been read out.

Here, this pixel position means the position of the pixel column (vertical column) in the image data after resolution conversion processing; these positions are allocated in sequence, 1, 2, 3, and so on, to each column, from the left-hand edge to the right-hand edge of the image. In other words, the position of the pixel means the line number in the print results relating to that pixel. As described previously, correction values are only stored with respect to one line, in relation to graduated tone values of a plurality of steps (p1 to p5) which correspond to the respective density regions (A1 to A5) of the test pattern. If the graduated tone value selected above as the object for correction matches the graduated tone value of one of the plurality of steps (p1 to p5), then the correction value associated with the matching graduated tone value is acquired, and the procedure then advances to S254 (search successful).

At S254, the image data correction module 21d multiplies the graduated tone value which is the object of correction by the correction value acquired by the search in S253, thereby correcting the graduated tone value under correction.

On the other hand, if the search for the correction value in S253 is not successful, then the procedure advances to S255, and a corrected value for the graduated tone value which is the object of correction is calculated by interpolation.

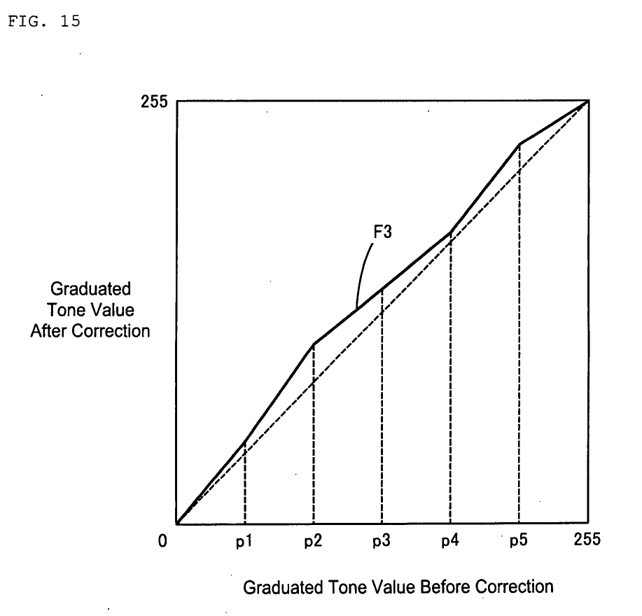

FIG. 15 shows one example of a function used for this interpolation process. FIG. 15 shows a two-dimensional plane where the vertical axis depicts the graduated tone value after correction and the horizontal axis depicts the graduated tone value before correction, and it depicts a corrective function F3 which corrects the print density of a particular line, in the print results obtained by using the nozzle row relating to the prescribed ink color, which is in a multiplexed relationship. More specifically, the image data correction module 21d generates a corrective function F3 as shown in FIG. 15 by linking together, by interpolation, the respective correction results for the graduated tone values of the plurality of steps (p1 to p5) obtained on the basis of the respective correction values corresponding to the graduated tone values of the plurality of steps (p1 to p5) corresponding to the pixel position, and the ink color of the graduated tone value which is the object of correction. The corrected values of the graduated tone value which is the object of correction are derived on the basis of the corrective function F3 thus generated. The corrective function F3 can be used commonly for the graduated tone values relating to the ink color selected at S252, in respect of all of the pixels which have a common position (column position) with respect to the pixel selected at S251, of the respective pixels in the image data.

At S256, the image data correction module 21d judges whether or not the graduated tone values relating to all of the ink colors CMYK have been selected in relation to the pixel selected in the previous execution of step S251, and if there are still ink colors which are pending (which have not yet been selected), then the procedure returns to S252, a pending ink color is selected, and the processing from S253 onwards is repeated. On the other hand, if it is judged that all of the graduated tone values relating to all of the ink colors CMYK have been selected in respect of the pixel selected in the previous execution of S251, then the procedure advances to S257.

At S257, the image data correction module 21d judges whether or not all of the pixels which constitute the image data have been selected as a pixel for correction, and if there are pixels which are pending (which have not yet been selected), then the procedure returns to S251, a pending pixel is selected as an object for correction, and the processing from S252 onwards is repeated. On the other hand, if it is judged that all of the pixels constituting the image data have been selected for correction, then the flowchart shown in FIG. 14 is terminated.

By executing the processing in step S250 in this way, the image data correction module 21d can be regarded as performing the function of an image data correction unit.

The sequence of processing in the steps S200 to S250 does not have to adhere strictly to the sequence shown in FIG. 10. For example, the determination of the usage ratio should have been carried out at least before the processing for generating correction data corresponding to the determined usage ratio, and furthermore, the processing for acquiring correction data from the printer 40 should have been carried out before the processing for generating correction data corresponding to the determined use ratio or the processing for correcting the image data.

At step S260, the half-tone processing module 21e executes half-tone processing in respect of the corrected image data. Consequently, half-tone data is obtained which specifies the on/off switching of the dots of the respective ink colors, for each pixel of the image data which represents the image to be printed.

At S270, the print data generation module 21f receives the half-tone data and converts this half-tone data to sequentially rearranged raster data for use by the printer 40, which it outputs successively to the printer 40. In this case, the print data generation module 21f assigns identification information for the nozzle row to be used in ejecting ink for each pixel, which specifies a ratio corresponding to the determined usage ratio, between the one nozzle row and the other nozzle row which are in a multiplexed relationship. In this case also, it is desirable that the nozzle rows should be used selectively according to the determined usage ratio, in each respective vertical column. As a result, if the determined usage ratio is 75% to 25% as described above, for example, then in printing the respective vertical columns of the image data, the pixels in 75% of the vertical columns are printed by using the nozzles 42a of the nozzle rows 41a1, 41a2, 41a3 and 41a4, and the pixels in the remaining 25% of the vertical columns are printed by using the nozzles 42a of the nozzle rows 41b1, 41b2, 41b3 and 41b4, thereby completing one printed image.

In the image which has been printed in this way, since the ink volume is corrected by means of correction values which compensate for deviation in the print density occurring in each line, when using one nozzle row and another nozzle row which are in a multiplexed relationship according to the determined usage ratio, then good overall image quality in which density non-uniformities are restricted is achieved. Since the computer 10 is able to execute the processing in steps S260 and S270, then it can be considered that a portion of its functions correspond to the ejection execution control unit. Alternatively, the term “ejection execution control unit” can be used to include the functions of the computer 10 which execute step S260 and S270, and the printer controller 47 in the printer 40, the head drive unit 45, and the like.

4. Determination the Usage Ratio

Next, the judgment standards used for deciding the usage ratio in step S220 will be described. One object of multiplexing the nozzle rows respectively for each ink color as in the present embodiment is to deal with the issue of heat generation in the nozzles. In other words, if the same nozzle is used continuously, then that nozzle retains heat and problems are more liable to occur in nozzles which have become very hot. Therefore, the correction data interpolation generating module 21c decides the usage ratio in the following manner, for example, by taking account of countermeasures against heat.

In step S220 described above, the correction data interpolation generating module 21c acquires the temperature of the first head unit 41a. In this case, a temperature sensor which measures the temperature at a prescribed position of the nozzle rows in the first head unit 41a is provided in the printer 40. In response to a request from the computer 10, the printer 40 sends the measurement result T for the temperature of the first head unit 41a at the time of receiving the request, to the computer 10. The correction data interpolation generating module 21c determines the usage ratio in accordance with the measurement result T.

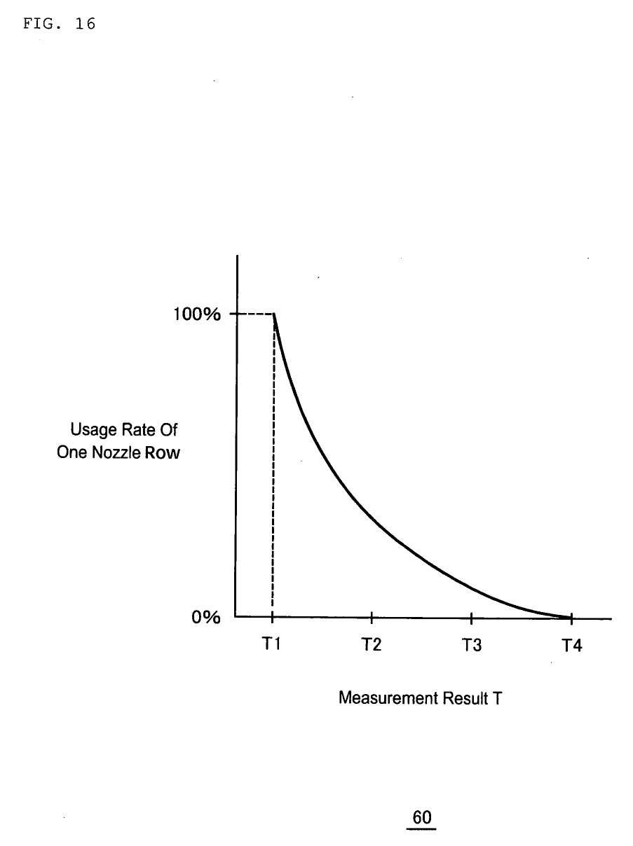

FIG. 16 is a usage ratio determination table 60 which shows one example of the relationship between the temperature of the first head unit 41a, and the usage ratio of one nozzle row of the nozzle rows which are in a multiplexed relationship, in other words, the nozzle row in the first head unit 41a. This table 60 specifies the correspondences between respective temperatures in the temperature range that the measurement result T is expected to take, and the usage ratio of the nozzle row in the first head unit 41a. In FIG. 16, the higher the measured temperature T, the lower the value of the usage ratio set for the nozzle row in the first head unit 41a. More specifically, if T≦T1, then the usage ratio is set to 100%, and if T≧T4, then the usage ratio is set to 0% (where T1<T2<T3<T4). In other words, if the measurement result T is equal to or less than T1, then the correction data interpolation generating module 21c determines a usage ratio of 100% to 0% between the one nozzle row and the other nozzle row of the nozzle rows which are in a multiplexed relationship, and if the measurement result T is equal to or greater than T4, then the correction data interpolation generating module 21c determines a usage ratio of 0% to 100% between the one nozzle row and the other nozzle row. If the measurement result T is a temperature between T1 and T4, then the usage ratio corresponding to that temperature is decided on the basis of the table 60 described above.

According to this composition, since the nozzle row currently having a higher temperature, of the one nozzle row and the other nozzle row which are in a multiplexed relationship, can be used with greater frequency, then it is possible to avoid problematic situations where, for instance, only one of the multiplexed nozzle rows is used with high frequency, and the temperature of that nozzle row becomes abnormally high.

In the foregoing description, the usage ratio is decided on the basis of the temperature of the first head unit 41a, but it is also possible to decide the usage ratio in accordance with the relative difference between the temperature of the first head unit 41a and the temperature of the second head unit 41b. In this case, the correction data interpolation generating module 21c acquires the temperature of the first head unit 41a and the temperature of the second head unit 41b in step S220. In other words, the printer 40 comprises, in addition to the temperature sensor described above, a temperature sensor which measures the temperature at a prescribed position of the nozzle rows of the second head unit 41b, and hence the measurement result Ta for the temperature of the first head unit 41a and the measurement result Tb for the temperature of the second head unit 41b are sent to the computer 10 in response to a request from the computer 10. The correction data interpolation generating module 21c determines the differential T between the measurement results Ta and Tb, as T=Ta−Tb. The usage ratio is decided on the basis of which of the divided ranges from T1 to T4, the differential T belongs to (in accordance with the usage ratio determination table 60 described above).

However, if the usage ratio is determined on the basis of the differential T, then the temperatures T1 to T4 in the usage ratio determination table 60 in FIG. 16 are re-read as threshold values T1 to T4, and these threshold values T1 to T4 are set so that T1<T2<T3<T4, T1 and T2 are prescribed negative values, and T3 and T4 are prescribed positive values. By adopting this composition, the nozzle row currently having the relatively lower temperature, of the one nozzle row and the other nozzle row which are in a multiplexed relationship, can be used more frequently, and therefore temperature increase can be suppressed appropriately in either nozzle row.

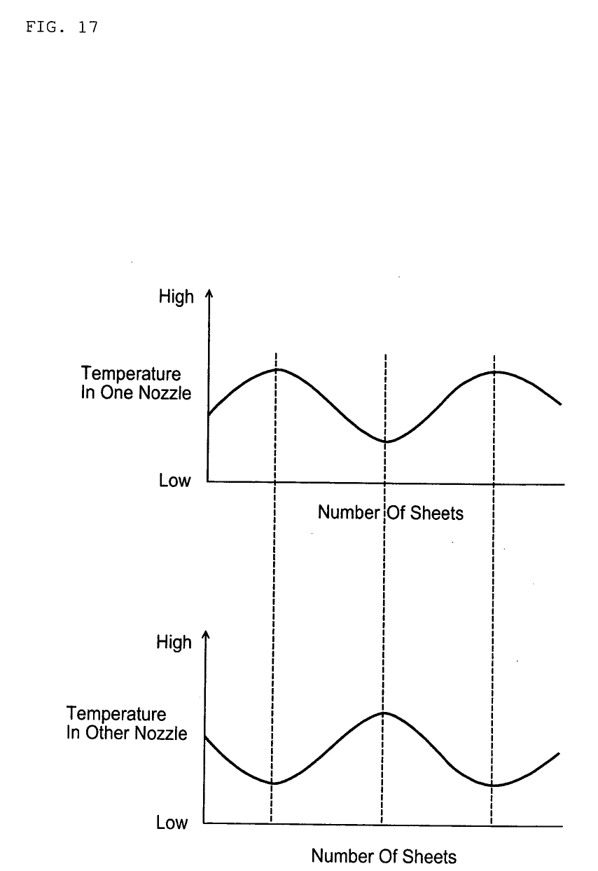

The method of determining a usage ratio by taking account of heat countermeasures is not limited to that described above. For example, it is possible to set the correction data interpolation generating module 21c so as to determine a usage ratio in such a manner that the temperature of one nozzle row of the multiplexed nozzle rows and the temperature of the other nozzle row of the multiplexed nozzle rows change in a substantially opposite phase relationship, as shown in FIG. 17. For example, the correction data interpolation generating module 21c determines a usage ratio by using a rule of gradually increasing the usage ratio of one nozzle row of the nozzle rows which are in a multiplexed relationship, from 50% to 100%, and then gradually decreasing this usage ratio from 100% to 0%, and then gradually increasing the usage ratio again from 0% to 100%. Of course, in this case, the usage ratio of the other nozzle row of the nozzle rows which are in a multiplexed relationship is reduced from 50% to 0%, and then increased from 0% to 100% and reduced again from 100% to 0%.

By switching the usage ratio in this way, the one nozzle row and the other nozzle row of the multiplexed nozzle rows have directly opposite rise and fall timings in respect of their nozzle usage rate, and therefore their temperature change curves, which show repeated temperature rise and temperature fall, have a substantially opposite phase relationship. Therefore, it is possible to avoid situations where both the one nozzle row and the other nozzle row become very hot, and therefore the product lifespan of both nozzle rows can be extended suitably. The usage ratio may be switched once per printed image sheet, or once every certain number of sheets. Alternatively, the correction data interpolation generating module 21c may regularly determine the measurement result T of the temperature sensor, and determine the usage ratio at each timing, in such a manner that the measurement result T changes as indicated by the upper curve in FIG. 17.

A further object of multiplexing the nozzle rows corresponding to the respective ink colors is to avoid the use of nozzles which are suffering an ejection failure. In other words, by multiplexing the nozzle rows corresponding to the respective ink colors, then even when a nozzle in one nozzle row is in a defective state, normal printing is achieved by using the other nozzle row. For example, in step S220 described above, the correction data interpolation generating module 21c acquires ejection defect information for the first head unit 41a. In this case, it is supposed that the printer 40 comprises an ink ejection determination sensor which determines the presence or absence of ink ejection in (all or a portion) of the nozzles 42a of the first head unit 41a. The printer 40 sends the past determination results of the ink ejection determination sensor, to the computer 10, on the basis of an ejection defect information request from the computer 10. The correction data interpolation generating module 21c also inputs this determination information, as ejection defect information, and analyzes the information; for example, if a prescribed number or more of the nozzles 42a in the first head unit 41a are in a defective state, then it is decided that the nozzle rows of the first head unit 41a are in a defective state.

In this case, the correction data interpolation generating module 21c set the usage ratio between the one nozzle row and the other nozzle row of the nozzle rows which are in a multiplexed relationship, to 100% to 0% (or to a ratio close to 100% to 0%). Therefore, all of the pixels or nearly all of the pixels which represent the image to be printed are printed by the nozzle rows in the second head unit 41b. Consequently, it is possible to avoid problems where printing is carried out by nozzle rows of the first head unit 41a where a large number of nozzles 42a are in a defective state. The printer 40 may also be provided with an ink ejection determination sensor which determines the presence or absence of ink ejection at (all or a portion of) the respective nozzles 42a of the second head unit 41b, and the correction data interpolation generating module 21c may determine the usage ratio in such a manner that a larger number of pixels are printed by the head unit which has the smaller number of nozzles 42a suffering an ejection defect, of the first head unit 41a and the second head unit 41b.

Moreover, the correction data interpolation generating module 21c may also determine the usage ratio in accordance with an instruction from an external source. More specifically, if an instruction relating to the usage ratio is issued by a user via the UI screen, or the like, as described above, then the usage ratio stated in this instruction is used in step S220. By adopting this composition, it is possible to use nozzle rows which are provided in a multiplexed arrangement, in accordance with a use ratio desired by the user.

5. Modification Examples

Various other modes relating to the present invention can be envisaged, apart from those described above.

In the foregoing description, an example was described in which correction data is generated in accordance with three different usage ratios (first to third usage ratios), prior to the print control processing, but the number of different usage ratios for which correction data is generated in advance can be set freely. If the respective correction data corresponding to a large number of usage ratios is determined in advance, then the accuracy of the interpolation result in step S240 is improved, and when respective correction data corresponding to two or more different usage ratios are determined, then the processing of determining the correction data is simplified, and only a small volume of correction data needs to be stored by the printer 40 and acquired by the correction data interpolation generating module 21c at step S230.

For example, at step S100, a test pattern TP4 for each ink color in which the usage ratio between the one nozzle row and the other nozzle row which are in a multiplexed relationship is set to 75% to 25% (for the sake of convenience, called a “fourth usage ratio”) is printed, a test pattern TP5 for each ink color in which the usage ratio between the one nozzle row and the other nozzle row is set to 25% to 75% (for the sake of convenience, called as “fifth usage ratio”) is printed, and in the step S110 described above, the measurement results from the test patterns TP4 and TP5 are input, and in the step S120 described above, corresponding correction data for each ink color can be generated respectively for the fourth and fifth usage ratios, on the basis of the measurement results for the test patterns TP4 and TP5. In this case, correction data for each ink color CMYK and each of the fourth and fifth usage ratios is stored on the storage medium of the printer 40. Furthermore, the respective image data stored here are constituted by correction values for each line number and each graduated tone value corresponding to the respective density regions of the test patterns.

If the respective correction data which correspond to the two different usage ratios in this way are generated in advance, then the processing in S241 is not required in the processing of step S240 (in FIG. 11) described above. In other words, the computer 10 acquires, as correction data 15c, only the correction data 15c corresponding to the fourth usage ratio and the correction data 15c corresponding to the fifth usage ratio, from the printer 40, and therefore these two sets of correction data 15c are always used as the correction data for carrying out interpolation.

In the processing from step S242 onwards, the correction data interpolation generating module 21c carries out interpolation corresponding to the determined usage ratio, by referring to the respective correction values recorded in the correction data 15c corresponding to the fourth usage ratio, and the respective correction values recorded in the correction data 15c corresponding to the fifth usage ratio, similarly to the embodiment described above. As a result, new correction data corresponding to the determined usage ratio is generated.

Here, in the step S240 described above, it is not absolutely necessary to generate new correction data by interpolation which refers to the actual correction data which has been generated previously as described above.

For example, if respective correction data corresponding to two different usage ratios is generated previously as described above, then the correction data interpolation generating module 21c may acquire from the printer 40 the coefficients of an approximation formula obtained by interpolation based on the respective correction values of these correction data. In this case, in the step S120 described above, in addition to calculating the correction values, it is necessary to determine the aforementioned coefficients on the basis of calculated correction values.

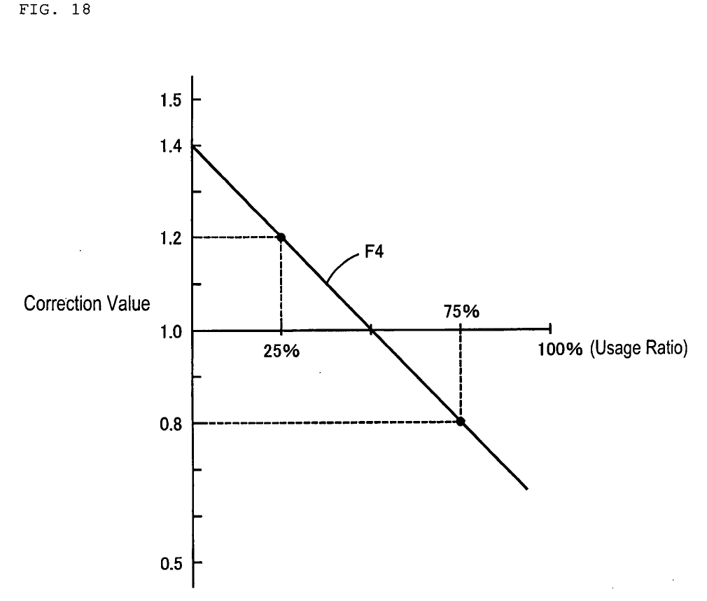

FIG. 18 shows one example of a mode of determining the coefficients described above.

For example, if the correction value corresponding to the graduated tone value p1 and the line number 1, as obtained from the measurement results of the test pattern TP4 printed with C ink, is “0.8”, and the correction value corresponding to the graduated tone value p1 and the line number 1, as obtained from the measurement results of the test pattern TP5 printed with the same C ink, is “1.2”, then an approximation formula which satisfies this correction value “0.8” and the correction value “1.2” is determined by linear interpolation. FIG. 18 shows a two-dimensional plane in which the vertical axis represents the correction value, and the horizontal axis represents the usage ratio (0 to 100%) of one of the nozzle rows which are in a multiplexed relationship. In FIG. 18, the correction value “0.8” is plotted at the position corresponding to the usage ratio 75% of the one nozzle row (nozzle row 41a1) used when printing the test pattern TP4, the correction value “1.2” is plotted at the position corresponding to the usage ratio 25% of the one nozzle row (nozzle row 41a1) used when printing the test pattern TP5, and a function F4 which links these two points by linear interpolation is also shown.

The function F4 described above, which is a primary function, is generally expressed as Y=αX+β, and in the case of function F4 above, the coefficient α=0.008 and the coefficient β=1.4. In this way, the coefficients α and β of the approximation formula corresponding to the graduated tone value p1 and the line number 1 are determined. The coefficients α and β of the approximation formula are calculated respectively for each set of correction values which have a matching ink color, graduated tone value and line number, by referring to the respective graduated tone values which have been recorded in the correction data for each ink color of CMYK and for the fourth usage ratio and the fifth usage ratio, respectively.

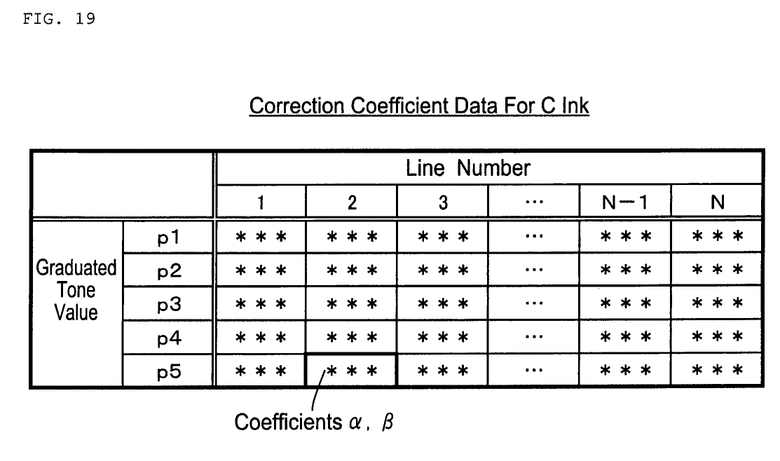

As a result, correction coefficient data comprising coefficients α and β as shown in FIG. 19 are generated respectively for each color of ink. In step S130 above, instead of the correction data for each ink color of CMYK and each of the fourth and fifth usage ratios, which is determined from the measurement results of the test patterns TP4 and TP5, it is also possible to store correction coefficient data for each of the ink colors, as described above, in a prescribed storage medium of the printer 40. If correction coefficient data is stored in the printer 40 in this way, then at step S230, the correction coefficient data for each ink color is acquired from the printer 40 and is stored as correction coefficient data 15d in a prescribed storage region of the HDD 15, or the like.

Thereupon, in step S240, the correction data interpolation generating module 21c calculates correction values on the basis of the set of coefficients α and β recorded in the correction coefficient data 15d for each ink color, and on the basis of the determined usage ratio. In other words, one correction value is calculated by substituting the usage rate X for the one nozzle row in the determined usage ratio, into the primary function which is defined by the set of coefficients α and β. This calculation of a correction value is repeated using all of the values for the coefficients α and β recorded in the respective correction coefficient data 15d for the respective ink colors. As a result, correction data is generated for each ink color which corresponds to the determined usage ratio.

In this way, by adopting a composition in which the coefficients of the approximation formula obtained by interpolation processing on the basis of the respective correction values of respective correction data which have been determined previously in relation to two different usage ratios, are taken and used for generating correction data corresponding to a determined usage ratio, then only a small volume of information need to be stored in the printer 40 at step S130, and only a small volume of information needs to be acquired from the printer 40 by the correction data interpolation generating module 21c during print control processing. Moreover, the actual processing carried out by the correction data interpolation generating module 21c in order to generate correction data corresponding to the determined usage ratio also becomes easier.

As a further modification example, it is also possible to generate the correction values in units of a group of lines which corresponds to a prescribed number of nozzles, rather than in a number corresponding to the number of nozzles 42a (number of lines N) used to print one image.

As shown in FIG. 2 and FIG. 3, the nozzle rows are formed by joining together a plurality of print heads. Therefore, for example, it is also possible to generate correction values for each group of lines consisting of a number of lines corresponding one row of nozzles which is formed in one print head 42 (print head 44) (in other words, corresponding to a small nozzle group, called a “small nozzle row”, which is surrounded by the broken line in FIGS. 2 and 3).

Since the nozzles which make up one small nozzle row are formed in the same print head, then it is considered that the difference between their respective ink ejection characteristics will be relatively small, whereas between different small nozzle rows, it is considered that the difference in the ink ejection characteristics will tend to be greater. This is because each line group in the print result is printed respectively by a particular set small nozzle row of the one nozzle row and the other nozzle row which are in a multiplexed relationship, and consequently, in the print result, there is little deviation in print density within the same line group, but the tendency of the print density varies greatly between different line groups.

In this case, at step S120 described above, the correction data generation module 24 divides up the correction values calculated for each line number 1 to N, into line group units corresponding to the number of nozzles in a small nozzle row, from one end, and determines the average of the correction values in each line group, thereby creating a correction value for each group. As a result of this, correctional data relating to the aforementioned plurality of usage ratios (the first to third usage ratios, and the fourth and fourth usage ratios, and so on) which consists of correctional values for each line group and each graduated tone value in the test pattern image data, is generated. By adopting this composition, it is only necessary to store a small volume of correction data. Furthermore, when correcting the pixels of the image data, it is possible to correct a number of pixels which are grouped together to a certain extent, on the basis of common correction values, and therefore the burden involved in the correction processing is reduced.

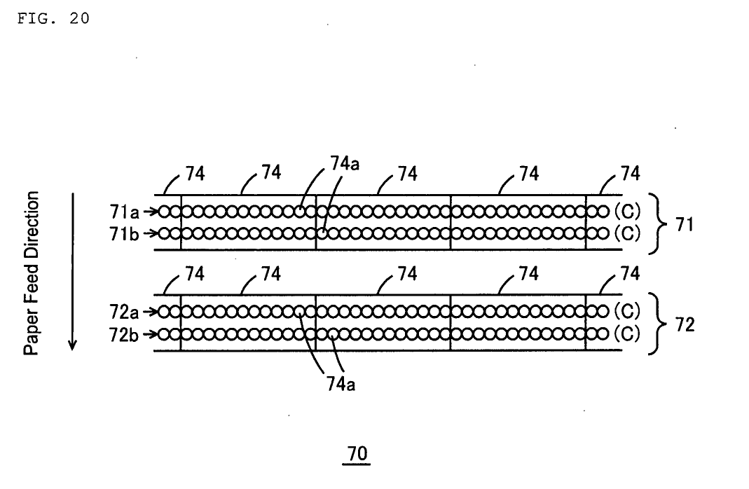

As a further modification example, it is possible for the printer 40 to use a print head unit 70 such as that shown in FIG. 20. This print head unit 70 comprises a first head unit 71 and a second head unit 72, and the respective head units 71 and 72 are composed by arranging a plurality of print heads 74 respectively in a direction that is perpendicular to the paper feed direction. The first head unit 71 and the second head unit 72 are composed respectively by a plurality of nozzle rows (in FIG. 20, by two nozzle rows). The nozzle rows 71a and 71b of the first head unit 71 and the nozzle rows 72a and 72b of the second head unit 72 are all nozzle rows which correspond to the same color of ink (for example, C ink), and in printing the respective pixels, it is possible to use either a nozzle 74a belonging to the nozzle group consisting of nozzle rows 71a and 71b, or a nozzle 74a belonging to the nozzle group consisting of nozzle rows 72a and 72b, selectively, in units of one pixel. Naturally, a plurality of nozzle groups consisting of a plurality of nozzle rows can also be provided for the other ink colors, in such a manner that a plurality of nozzle groups are used selectively, for each color of ink. Therefore, in the example shown in FIG. 20, the nozzle groups corresponding to the respective ink colors are each multiplexed.

By adopting this composition, when printing a test pattern on the basis of the first usage ratio or the third usage ratio described above, in other words, when printing a test pattern by only using one nozzle group, of the nozzle groups which are in a multiplexed relationship, the nozzles 74a which constitute the nozzle group can be divided into print head 74 units, and a common correction value can be generated for each nozzle 74a (small nozzle group) which is formed in the same print head 74. In other words, it is considered that the nozzles 74a formed in the same print head 74 will essentially have little difference in respect of their ink ejection characteristics, whereas it is thought that there will be a large difference in the tendency of ink ejection characteristics, between different print heads 74. In this case, in step S120 described above, the correction data generation module 24 finds the average, for each unit group of lines printed by each print head 74, of the correction values calculated for each line of the nozzle group (for example, the nozzle rows 71a and 71b of the first head unit 71), and thereby generates calculation values for each of the print heads 74. Consequently, respective correction data consisting of correction values for each print head 74 and for each graduated tone value of the test pattern image data are generated as correction data relating to the first and the third usage ratios. If a test pattern is printed at a usage ratio other than the first or third usage ratios described above, using the print head unit shown in FIG. 20, then the correction data generation module 24 can generate correction values in the following manner. At step S120 described above, the correction data generation module 24 divides up the correction values calculated for each line number 1 to N, into line group units corresponding to the number of lines which can be printed by the print head 74, from one end, and determines the average of the correction values in this line group, thereby creating a correction value for the line group.

As a result of this, correctional data relating to the aforementioned plurality of usage ratios (the first to third usage ratios, and the fourth and fourth usage ratios, and so on) which consists of correctional values for each line group and each graduated tone value in the test pattern image data, is generated. By adopting this composition, it is only necessary to store a small volume of correction data. Furthermore, when correcting the pixels of the image data, it is possible to correct a number of pixels which are grouped together to a certain extent, on the basis of common correction values, and therefore the burden involved in the correction processing is reduced.

Moreover, the process of determining the usage ratio may also be carried out independently in respect of each ink color. In other words, upon receiving color converted image data from the color conversion module 21b, the correction data interpolation generating module 21c may decide a usage ratio for each ink color and generate correction data for each ink color in accordance with the determined usage ratio for each ink color. Furthermore, the print data generation module 21f appends identification information corresponding to the determined usage ratio of each ink color, to the raster data of each ink color. This composition is useful from the viewpoint of dealing with the generation of heat, and avoiding the use of defective nozzles.

For example, in the printer 40, if it is possible to measure the temperature in each nozzle row which corresponds to a different ink color, then it can be reliably expected that different measurement results will be obtained for each nozzle row. Therefore, by the correction data interpolation generating module 21c, the usage ratio is decided for each ink color by referring to the usage ratio determination table 60 in FIG. 16, for example, in accordance with the temperature measurement results for each nozzle row. Consequently, it is possible to make selective use of the multiplexed nozzle rows in a manner which suits the temperature situation of the nozzle rows of the respective ink colors, and therefore an optimal countermeasure against heat can be achieved. Furthermore, when analyzing the ejection defect information, the correction data interpolation generating module 21c may also count the number of nozzles which are in a defective state, in each nozzle row, and determine the usage ratio for each of the ink colors corresponding to the respective nozzle rows, on the basis of the count results for each nozzle row. If this selection process is adopted, then, it is possible to achieve fine control whereby, for example, of the nozzle rows 41a1, 41a2, 41a3, and 41a4 belonging to the first head unit 41a, only those nozzle rows which have a large number of nozzles 42a in a defective state are switched to use nozzle rows 41b1, 41b2, 41b3, 41b4 in the second head unit 41b.

6. Summary

In this way, according to the present embodiment, a structure is adopted in which the nozzle groups (nozzle rows, and the like) corresponding to the respective ink colors are multiplexed in the printer 40, and the computer 10 generates, respectively for different usage ratios of the nozzle groups which are in a multiplexed relationship, correction data for correcting non-uniformities in the print results which are caused by fluctuation in the ink ejection characteristics of the nozzles. Thereupon, in the print control processing based on image data which represents the image to be printed, the computer 10 decides the usage ratio (determined usage ratio) between the nozzle groups used for printing, and also generates correction data corresponding to the determined usage ratio, by carrying out interpolation processing corresponding to the determined usage ratio, through reference to the correction data for the respective different usage ratios which has been generated as described above. The image to be printed is then printed by correcting the image data by means of the correction data corresponding to the determined usage ratio, and by controlling the driving of the respective nozzle groups on the basis of the corrected image data and the determined usage ratio.

According to the composition described above, it is possible to generate correction data corresponding to any usage ratio, on the basis of correction data which has been determined previously in respect of a limit number of different usage ratios, and therefore it is possible to correct the image data in a fashion which suits various modes of selective use of the multiplexed nozzle groups of the printer 40, readily, by using a small volume of information. Furthermore, the respective lines which are printed by the respective nozzle groups that are in a multiplexed relationship have their ink volumes corrected by correction values which are adapted to suppressing density non-uniformities arising in accordance with the usage ratio of the nozzle groups in that particular case, and therefore, extremely good image quality which is free of density non-uniformities is obtained in the overall image which is printed by the respective nozzle groups.

It is also possible for all or a portion of the respective processes performed by the computer 10 above, and in particular the processes shown in FIGS. 4 and 10, to be carried out in the printer 40. In this case, the printer 40 becomes one example of a liquid ejection apparatus.

In the foregoing description, the composition of a liquid ejection control apparatus and liquid ejection apparatus was applied principally to a printer 40 which is an inkjet recording apparatus, or to an apparatus comprising such as printer 40, but the scope of application of the above-described composition of a liquid ejection control apparatus and liquid ejection apparatus is not limited to this. For example, it may also be applied to a liquid ejection apparatus which ejects a liquid other than ink (including liquids in which particles of organic material are dispersed, or fluids such as gels), or which ejects a fluid other than liquid (for instance, a solid which can be ejected by being caused to flow in the form of a fluid). For example, this composition may be used in: a liquid ejection apparatus which ejects a material in the form of a liquid containing electrode material, coloring material, or the like, in dispersed or dissolved form, as used in the manufacture of liquid crystal displays, EL (electroluminescence) displays, or a surface emitting display; a liquid ejection apparatus which ejects biological organic material as used in biochip manufacture; or a liquid ejection apparatus which is used as a precision pipette device and ejects liquid forming samples. Other possible applications are: a liquid ejection apparatus which ejects lubricating oil in a pinpoint fashion onto high-precision machinery, such a watch or a camera; a liquid ejection apparatus which ejects a transparent resin liquid, such as ultraviolet-curable resin, onto a substrate, in order to form miniature hemispherical lenses (optical lenses) for use in optical communications elements, and the like; a liquid ejection spray apparatus which ejects etching liquid, such as an acid or alkali liquid, in order to etch a substrate, or the like; a fluid ejection apparatus which ejects a gel; or a powder ejection recording apparatus which ejects a solid, for example, a powder such a toner, or the like.

While the invention has been particularly shown and described with respect to preferred embodiments thereof, it should be understood by those skilled in the art that the foregoing and other changes in form and detail may be made therein without departing from the sprit and scope of the invention as defined in the appended claims.

What is claimed is:

1. A liquid ejection control apparatus which controls a liquid ejection mechanism having a plurality of nozzle groups made up of a plurality of nozzles for ejecting liquid, comprising:
a usage ratio determination unit which determines a usage ratio between the plurality of nozzle groups when performing liquid ejection;
a correction data generation unit which generates correction data corresponding to the determined usage ratio, by using respective correction data for correcting density of liquid ejection results corresponding respectively to a plurality of usage ratios between the nozzle groups;
an image data correction unit which corrects prescribed image data on the basis of the generated correction data; and
an ejection execution control unit which executes liquid ejection by driving the respective nozzle groups on the basis of the corrected image data and the determined usage ratio.

2. The liquid ejection control apparatus according to claim 1, wherein the correction data generation unit generates correction data corresponding to the determined usage ratio, by acquiring the respective correction data corresponding to the plurality of usage ratios, and carrying out interpolation in accordance with the determined usage ratio by referring to the respective correction data thus acquired.

3. The liquid ejection control apparatus according to claim 1, wherein the correction data generation unit acquires coefficients of an approximation formula obtained by interpolation on the basis of the respective correction data corresponding to the plurality of usage ratios, and generates correction data corresponding to the determined usage ratio on the basis of the coefficients and the determined usage ratio.

4. The liquid ejection control apparatus according to claim 1, wherein the usage ratio determination unit determines the usage ratio on the basis of a state of the liquid ejection mechanism, or an instruction from an external.

5. The liquid ejection control apparatus according to claim 4, wherein the usage ratio determination unit acquires temperature of the nozzle group and determines the usage ratio in accordance with this temperature.

6. The liquid ejection control apparatus according to claim 4, wherein the usage ratio determination unit acquires ejection defect information for the nozzle group and determines the usage ratio on the basis of this ejection defect information.

7. The liquid ejection control apparatus according to claim 1, wherein the correction data generation unit generates a correction value for each line corresponding to the determined usage ratio, by acquiring and using correction values relating to each line for correcting deviation in densities of the respective lines, from respective liquid ejection results corresponding to respective usage ratios, which form the respective correction data corresponding to the plurality of usage ratios, and the image data correction unit corrects graduated tone values of respective pixels in the image data on the basis of the correction values generated in relation to the line to which each pixel corresponds.

8. The liquid ejection control apparatus according to claim 1, wherein the correction data generation unit generates a correction value for each line group in units of the prescribed number of lines corresponding to the determined usage ratio, by acquiring and using correction values relating to each line group for correcting deviation in densities of the respective line groups, from respective liquid ejection results corresponding to respective usage ratios, which form the respective correction data corresponding to the plurality of usage ratios, and the image data correction unit corrects graduated tone values of respective pixels in the image data on the basis of the correction values generated in relation to the line group to which each pixel corresponds.

9. A liquid ejection control method for controlling a liquid ejection mechanism having a plurality of nozzle groups made up of a plurality of nozzles for ejecting liquid; the method comprising:
determining a usage ratio between the plurality of nozzle groups when performing liquid ejection;
generating correction data corresponding to the determined usage ratio, by using respective correction data for correcting density of liquid ejection results corresponding respectively to a plurality of usage ratios between the nozzle groups;
correcting prescribed image data on the basis of the generated correction data; and
executing liquid ejection by driving the respective nozzle groups on the basis of the corrected image data and the determined usage ratio.

10. A liquid ejection apparatus having a plurality of nozzle groups made up of a plurality of nozzles for ejecting liquid, comprising:
a usage ratio determination unit which determines a usage ratio between the plurality of nozzle groups when performing liquid ejection;
a correction data generation unit which generates correction data corresponding to the determined usage ratio, by using respective correction data for correcting density of liquid ejection results corresponding respectively to a plurality of usage ratios between the nozzle groups;
an image data correction unit which corrects prescribed image data on the basis of the generated correction data; and
an ejection execution unit which executes liquid ejection by controlling driving of the respective nozzle groups on the basis of the corrected image data and the determined usage ratio.
